(19) United States
(12) Patent Application Publication
(10) Pub. No.: US 2025/0060517 A1
(43) Pub. Date: Feb. 20, 2025

(54) OPTICAL SYSTEM COMPRISING AN EUV MIRROR AND METHOD FOR OPERATING AN OPTICAL SYSTEM

(71) Applicant: Carl Zeiss SMT GmbH, Oberkochen (DE)

(72) Inventors: Hartmut Enkisch, Aalen (DE); Birgit Enkisch, Aalen (DE)

(21) Appl. No.: 18/802,211

(22) Filed: Aug. 13, 2024

(30) Foreign Application Priority Data
Aug. 14, 2023 (DE) 102023121686.4

(51) Int. Cl. G02B 5/08

(52) U.S. Cl. CPC G02B 5/0891; G02B 5/0808

(57) ABSTRACT

An optical system comprising an EUV mirror, wherein the EUV mirror is provided with an optical surface designed for the reflection of EUV radiation. An EUV beam path generated by an EUV radiation source is directed at the optical surface of the EUV mirror, such that the EUV beam path is incident on the EUV mirror at an angle of not more than 12°. The optical surface is covered with a carbon layer, wherein the carbon layer has a thickness of at least 8 nm. The invention also relates to a method for operating an optical system.

### CROSS-REFERENCE TO RELATED APPLICATION

The present application claims priority from German patent application DE 10 2023 121 686.4, filed on Aug. 14, 2023, the entire contents of which are incorporated herein by reference.

### TECHNICAL FIELD

The invention relates to an optical system comprising an EUV mirror and to a method for operating an optical system.

### BACKGROUND

Microlithographic projection exposure apparatuses are used for the production of integrated circuits with particularly small structures. A photomask illuminated by very short-wave extreme ultraviolet radiation (EUV radiation) is imaged on a lithography object in order to transfer the mask structure to the lithography object.

The projection exposure apparatus comprises a plurality of EUV mirrors which comprise an optical surface at which the EUV radiation is reflected. In order to keep down the losses of EUV radiation within the projection exposure apparatus, the EUV mirrors have an optical surface with high reflectivity for EUV radiation.

In addition to the projection exposure apparatus itself, there are further optical systems that are operated in connection with microlithographic projection exposure apparatuses. These include, for example, measuring devices that are used to examine the reflectivity of EUV mirrors, devices for examining modules and subsystems, and measuring devices that are used to examine the properties or the state of photomasks.

In all cases, the problem can arise that the optical surface of an EUV mirror used in the optical system is contaminated by deposition of carbon-containing species, such that the reflectivity of the EUV mirror decreases further and further during the operation of the optical system. In general, an optical system already becomes unusable if just a single one of the EUV mirrors used in the optical system no longer has sufficient reflectivity. It can therefore have a shortening effect on the service life of an optical system if a carbon layer is deposited on an EUV mirror of the optical system during operation.

### SUMMARY

The invention is based on the aspect of presenting an optical system comprising an EUV mirror and a method for operating an optical system which avoid these disadvantages. The aspect is achieved by the features of the independent claims. Advantageous embodiments are specified in the dependent claims.

The optical system according to the invention comprises an EUV mirror. The EUV mirror is provided with an optical surface designed for the reflection of EUV radiation. An EUV beam path generated by an EUV radiation source is directed at the optical surface of the EUV mirror, such that the EUV radiation is incident on the EUV mirror at an angle of not more than 12°. The EUV mirror is therefore operated with grazing incidence. The optical surface is covered with a carbon layer, wherein the carbon layer may have a thickness of at least 8 nm. If there is a range of propagation directions of the EUV radiation within the EUV beam path, as is the case, for example, with a convergent or divergent beam path, the angular information relates to the central ray of the EUV beam path.

The invention is based on the insight that the influence that a carbon layer deposited on the optical surface of the EUV mirror has on the reflectivity is greatly dependent on the angle at which the EUV radiation is incident on the EUV mirror. For grazing-incidence EUV mirrors, the angle between the EUV radiation and the optical surface is often of the order of magnitude of 20°. Significantly smaller angles are regarded as not very expedient. Although it is possible to further increase the reflectivity of an individual EUV mirror by using smaller angles, a higher number of EUV mirrors is required in order to achieve a specific degree of beam deflection.

For an EUV mirror on which the EUV radiation is incident at an angle of 20°, the reflectivity decreases to about 50% if the carbon layer reaches a thickness of 10 nm. In other words, only 50% of the EUV radiation is reflected compared with an initial state in which the optical surface of the EUV mirror is not yet contaminated by contaminations. In general, such a decrease in reflectivity means that an optical system can no longer be expediently used.

The invention proposes significantly reducing the angle at which the EUV radiation is incident on the EUV mirror by comparison with previously customary values in order to attain an optical system which still functions even if the optical surface is covered with a carbon layer having a thickness of 8 nm or more. By way of example, if an EUV mirror operated at an angle of 10° is considered, this EUV mirror still has a reflectivity of more than 80% if the carbon layer is 10 nm thick.

If the incident EUV radiation has an incidence angle bandwidth, portions of the EUV radiation that lie in different ranges of the incidence angle bandwidth are reflected to different extents. In one embodiment, the system according to the invention is operated in such a way that those portions of the incident EUV radiation which form the largest angle with the optical surface of the EUV mirror within the incidence angle bandwidth are incident on the optical surface of the EUV mirror at an angle of not more than 12°. The angle at which the central ray of the EUV radiation is incident is then correspondingly smaller. The term incidence angle bandwidth denotes the FWHM bandwidth.

During the operation of an optical system according to the invention, carbon-containing species arise as a result of interaction between the EUV radiation and a residual gas remaining in the vacuum atmosphere of the system and deposit on the optical surface of EUV mirrors and form a layer on the optical surface after a relatively long period of operation. A carbon layer within the meaning of the invention is a layer having a composition such as typically arises during the operation of an EUV system. Relative to the number of particles in the carbon layer, carbon generally accounts for at least 60%, preferably at least 70%. The carbon layer can contain an oxygen proportion of between 5% and 30%. The proportion of the remaining constituents in the carbon layer can be less than 20%.

The carbon layer can be a carbon layer deposited during the operation of the optical system. This means that the optical surface is not covered with a carbon layer when the EUV mirror is manufactured. The carbon layer forms only as a result of the use of the EUV mirror under the EUV conditions of the optical system. The invention opens up the possibility of still continuing to operate the optical system even if the carbon layer has grown beyond 8 nm. For example, the carbon layer can have a thickness of at least 10 nm, preferably of at least 15 nm, with further preference of at least 30 nm.

In the case of grazing-incidence EUV mirrors, in which the EUV radiation is thus incident on the EUV mirror at an angle of 25° or less, a high reflectivity for EUV radiation can be achieved if the optical surface is formed by a single layer. For example, the reflection layer can consist of ruthenium (Ru). A reflection layer consisting of more than one layer is also possible. The reflection layer can consist of one or more other materials. In particular, the reflection layer can comprise one or more of the materials ruthenium (Ru), rhodium (Rh), palladium (Pd), gold (Au), platinum (Pt), niobium (Nb), molybdenum (Mo) and zirconium (Zr). The thickness of the reflection layer can be for example between 20 nm and 200 nm, preferably between 30 nm and 80 nm.

In contrast thereto, in the case of a normal-incidence EUV mirror, in which the angle between the incident EUV radiation and the optical surface of the EUV mirror is thus between 60° and 90°, sufficient reflectivity for EUV radiation can only be achieved with a reflection layer system constructed from a plurality of layers.

The EUV mirror can comprise a mirror body, on which the optical surface is formed. The mirror body can consist of a material whose coefficient of thermal expansion has a zero crossing temperature (ZCT). One example of such a material is a titanium silicate glass known as ULE (Ultra Low Expansion Glass), as offered by Corning Incorporated, for example.

The consideration that an excessively small angle between the incident EUV radiation and the optical surface is not expedient also applies to the EUV mirror according to the invention. With a smaller angle, a larger number of EUV mirrors is required in order to achieve a specific beam deflection, resulting overall in more disadvantages than advantages. The angle between the incident EUV beam path and the optical surface can therefore be at least 4°, preferably at least 6°, preferably at least 8°.

The optical system can comprise a first EUV mirror and a second EUV mirror, wherein each of the two EUV mirrors can have one or more features described in the context of the one EUV mirror. The difference between the angles at which the EUV radiation is incident on the first EUV mirror and the second EUV mirror can be less than 6°, preferably less than 4°, with further preference less than 2°.

The first EUV mirror and the second EUV mirror can have the same incidence plane. Incidence plane denotes the plane that is spanned at an EUV mirror by the central ray of the incident EUV beam path and the central ray of the reflected EUV beam path. The beam deflection caused by the two EUV mirrors then takes place within one plane.

The first EUV mirror and the second EUV mirror can jointly effect a beam deflection of the EUV beam path which is between 24° and 48°, preferably between 30° and 40°. Beam deflection denotes the angle formed between the EUV radiation incident on the first EUV mirror and the EUV radiation reflected at the second EUV mirror. As viewed in the direction of propagation of the EUV radiation, the EUV radiation is incident firstly on the first EUV mirror and then on the second EUV mirror. The beam deflection can take place within one plane.

The optical system can be designed such that no further optical element that modifies the direction of the EUV beam path is arranged between the first EUV mirror and the second EUV mirror. The optical system can comprise more than two EUV mirrors, wherein each of the EUV mirrors has one or more features of an EUV mirror according to the invention.

The optical system can comprise one or more EUV mirrors on which the EUV beam path is incident at an angle of more than 12°. These can include one or more grazing-incidence EUV mirrors and/or one or more normal-incidence EUV mirrors, in which the angle between the incident EUV radiation and the optical surface of the EUV mirror is thus between 60° and 90°. One insight according to the invention is that the reflectivity of an optical surface with normal incidence is adversely affected by a carbon layer deposited during operation only to a lesser extent compared to the situation with grazing incidence. In many cases, a normal-incidence EUV mirror can be expediently used up to a thickness of the carbon layer of 20 nm, for example. Assuming that the carbon layer builds up on all EUV mirrors of the optical system at the same rate, a range for the layer thickness of the carbon layer is accordingly opened up which extends beyond 10 nm and within which an optical system comprising EUV mirrors according to the invention and normal-incidence EUV mirrors can be expediently used.

Since the rate at which carbon layers build up on the optical surfaces of the EUV mirrors of the optical system also depends on the local intensity of the EUV radiation, there are optical systems in which the carbon layer builds up at different rates on different EUV mirrors. In such an optical system, EUV mirrors according to the invention can be arranged in the sections of the EUV beam path in which the carbon layer builds up quickly, and the EUV mirrors not according to the invention can be arranged in such sections of the EUV beam path in which the carbon layer builds up less quickly.

Since gases generally have a low transmission for EUV radiation, it is advantageous if the optical system is operated under vacuum. The optical system can comprise a vacuum housing, in the interior of which the EUV mirrors are arranged. Negative pressure can prevail in the interior of the vacuum housing during operation of the optical system.

The negative pressure to which the components in the vacuum housing are subjected can cause outgassing from components arranged in the vacuum housing. Interaction between the outgassing and the EUV radiation can produce the contaminants from which the carbon layer forms. To slow down the formation of the carbon layer, a hydrogen purge gas can be introduced into the vacuum housing. Interaction between the EUV radiation and the hydrogen creates a plasma, forming ionic plasma species (H⁺) or free-radical plasma species (H) inter alia. The hydrogen plasma has the effect of removing contaminations from the surfaces of the components in the vacuum housing. The optical system according to the invention can be operated under such a hydrogen atmosphere.

In one embodiment, the optical system is operated in a vacuum atmosphere without hydrogen purge gas. In this way, the equipment costs can be reduced. The disadvantage that the carbon layers build up more quickly on the EUV mirrors of the optical system is compensated for according to the invention by the fact that carbon layers of greater thickness can be permitted before the optical system becomes unusable.

The optical system according to the invention can be designed to illuminate a photomask or a portion of a photomask with EUV radiation. Illumination means that a surface is irradiated with substantially uniform brightness. The optical system according to the invention can alternatively or additionally be designed to image a photomask into an object plane. A wafer can be arranged in the object plane, which wafer is exposed on the basis of a structure formed on the photomask. It is also possible for an EUV image sensor to be arranged in the object plane, such that an image of the photomask can be recorded by the EUV image sensor. The photomask can have an aspect ratio of between 1:1 and 1:3, preferably between 1:1 and 1:2, particularly preferably of 1:1 or 1:2. The photomask can be of substantially rectangular design. The photomask can be 12.70 cm (5 inches) to 17.78 cm (7 inches) long and wide, preferably 15.24 cm (6 inches) long and wide. As an alternative thereto, the photomask can be 12.70 cm (5 inches) to 17.78 cm (7 inches) long and 25.40 cm (10 inches) to 35.56 cm (14 inches) wide, preferably 15.24 cm (6 inches) long and 30.48 cm (12 inches) wide.

In an alternative embodiment, the optical system according to the invention is designed to guide the EUV radiation onto a measurement object. In addition or as an alternative thereto, the optical system can be designed to direct EUV radiation reflected at a measurement object onto a detector. The optical system can be used for example for the purpose of obtaining a measured value about the reflectivity of the measurement object. The detector can be designed to determine the intensity of the incident EUV radiation. In one variant, the detector is an EUV image sensor.

The term EUV radiation denotes electromagnetic radiation in the extreme ultraviolet spectral range with wavelengths of between 5 nm and 100 nm, in particular with wavelengths of between 5 nm and 30 nm. In particular, the EUV radiation can have a wavelength of 13.5 nm.

The invention also relates to a method for operating an optical system in which an EUV beam path generated by an EUV radiation source is directed at an optical surface of an EUV mirror. The EUV beam path is directed at the EUV mirror at an angle of not more than 12°. The optical surface is covered with a carbon layer. The carbon layer may have a thickness of at least 8 nm.

The disclosure content encompasses developments of the method which are described in the context of the optical system according to the invention. The disclosure content encompasses developments of the optical system which are described in the context of the method according to the invention.

### BRIEF DESCRIPTION OF DRAWINGS

The invention is described by way of example below on the basis of advantageous embodiments with reference to the accompanying drawings, in which:

FIG. 1: shows a microlithographic projection exposure apparatus;

FIG. 2: shows an EUV mirror of the projection exposure apparatus from FIG. 1;

FIG. 3: shows a detail of the EUV mirror from FIG. 2 in an enlarged illustration;

FIGS. 4, 5: show the view in accordance with FIG. 3 in other states of the EUV mirror;

FIG. 6: shows a device for examining photomasks;

FIG. 7: shows two EUV mirrors of the device from FIG. 6;

FIG. 8: shows a device for examining the reflection properties of a measurement object;

FIG. 9: shows an illustration of the reflectivity of an EUV mirror as a function of the angle of incidence;

FIG. 10: shows an illustration of the reflectivity of a single EUV mirror as a function of the thickness of the carbon layer;

FIG. 11: shows an illustration of the reflectivity of a combination of a plurality of EUV mirrors as a function of the thickness of the carbon layer.

### DETAILED DESCRIPTION

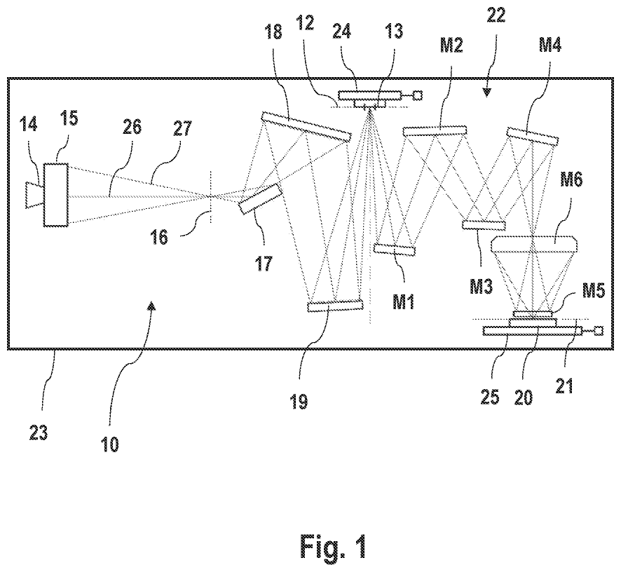

FIG. 1 schematically illustrates an example of a microlithographic EUV projection exposure apparatus. The projection exposure apparatus comprises an exposure beam source 14, an illumination system 10 and a projection lens 22, which are operated jointly in a vacuum chamber 23. Negative pressure prevails in the vacuum chamber 23 during the operation of the EUV projection exposure apparatus.

The exposure beam source 14 generates electromagnetic radiation in the EUV range with a wavelength of, e.g., 13.5 nm. The exposure radiation emanating from the exposure beam source 14 is focused on an intermediate focal plane 16 by way of a collector 15. The EUV beam path 27 crossing from the intermediate focal plane 16 and having a central ray 26 is guided into an object plane 12 by the illumination system 10, such that an object field in the object plane 12 is illuminated with uniform radiation intensity.

The illumination system 10 comprises a deflection mirror 17, by which the EUV beam path 27 is deflected onto a first facet mirror 18. A second facet mirror 19 is disposed downstream of the first facet mirror 18. The second facet mirror 19 is used to image the facets of the first facet mirror 18 in the object plane 12.

A photomask 13 is arranged in the object plane 12, and is imaged in an image plane 21 by way of a plurality of mirrors M1-M6 of the projection lens 22. A structure formed on the photomask 13 is transferred to a radiation-sensitive layer of a wafer 20 arranged in the image plane 21. The photomask 13 is suspended from a first scanning device 24, and the wafer 20 is at rest on a second scanning device 25 such that the wafer 20 can be exposed in a scanning procedure during which the photomask 13 and the wafer 20 are moved synchronously with one another.

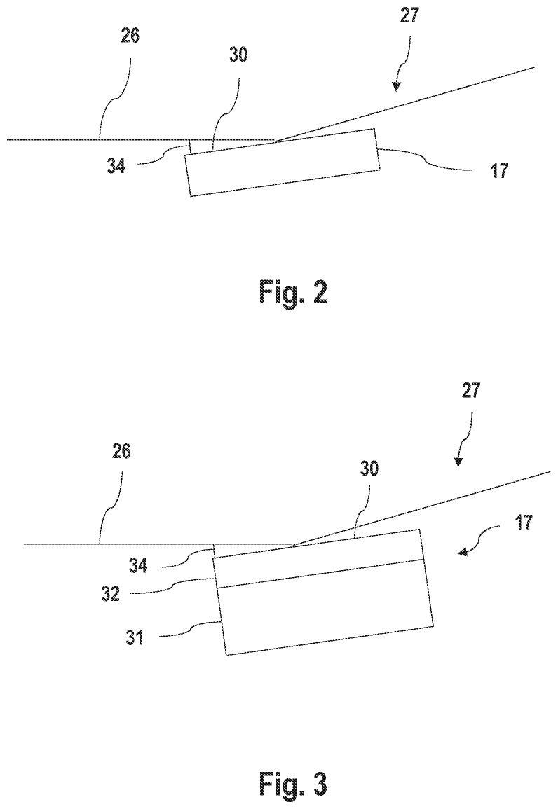

The optical elements of the projection exposure apparatus which shape and deflect the EUV beam path 27 form an optical system within the meaning of the invention. The optical system comprises an EUV mirror in the form of the deflection mirror 17, at the optical surface 30 of which the EUV beam path 27 is reflected, see FIG. 2. The central ray 26 of the EUV beam path 27 incident on the optical surface 30 forms an angle 34 of 10° with the optical surface 30.

In accordance with the enlarged illustration in FIG. 3, the deflection mirror 17 comprises a mirror body 31, which consists of a titanium silicate glass with ultra-low thermal expansion (“Ultra-Low-Expansion Material”). The mirror body 31 is covered with a reflection layer 32, which in this exemplary embodiment consists of ruthenium. The reflection layer 32 can have a thickness of the order of magnitude of, for example, 50 nm.

The reflection layer 32 of ruthenium has a high reflectivity for EUV radiation which is incident at a small angle, i.e. with grazing incidence. The angle refers to the angle between the EUV radiation and the optical surface. Since the other EUV mirrors of the projection exposure apparatus also have a high reflectivity for EUV radiation, the wafer 20 can be exposed with a sufficiently high intensity of EUV radiation.

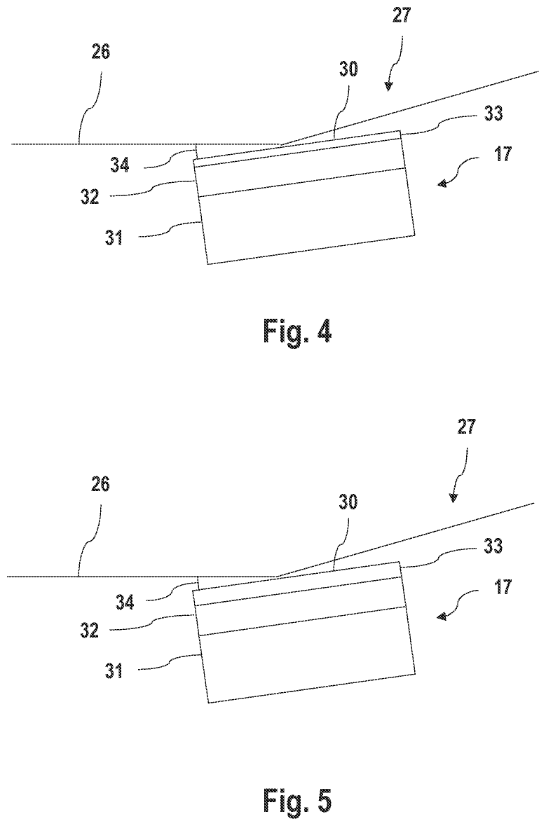

During the operation of the projection exposure apparatus, contaminants are deposited on the reflection layer 32, and over time form a carbon layer 33. In FIG. 4, the deflection mirror 17 is illustrated in a state in which the carbon layer 33 has built up to a thickness of 10 nm. Compared with the state illustrated in FIG. 3, the reflectivity of the deflection mirror 17 decreases by about 20% as a result of the 10 nm-thick carbon layer 33. This loss of reflectivity is significantly lower than in EUV mirrors which are operated conventionally with grazing incidence and where the EUV radiation is incident at an angle of, for example, 20°. In this document, the phrase “the EUV radiation is incident at an angle of X°” means that the angle between the EUV radiation and the optical surface is X°. The loss of reflectivity would then already be of the order of magnitude of 50% and thus so high that an expedient use of the optical system would no longer be possible.

This is evident from FIG. 9, which illustrates the reflectivity of an EUV mirror as a function of the angle at which the EUV radiation is incident on the optical surface of the EUV mirror. The horizontal axis represents the angle between the EUV radiation and the optical surface, and the vertical axis represents the reflectivity of the EUV mirror. A first curve 62 shows the profile of the reflectivity in the angular range between 0° and 30° for an EUV mirror whose optical surface is free of a carbon layer. A second curve 63 shows the profile for a 5 nm-thick carbon layer, a third curve 64 shows the profile for a 10 nm-thick carbon layer, a fourth curve 65 shows the profile for a 20 nm-thick carbon layer, a fifth curve 66 shows the profile for a 30 nm-thick carbon layer and a sixth curve 75 shows the profile for a 40 nm-thick carbon layer.

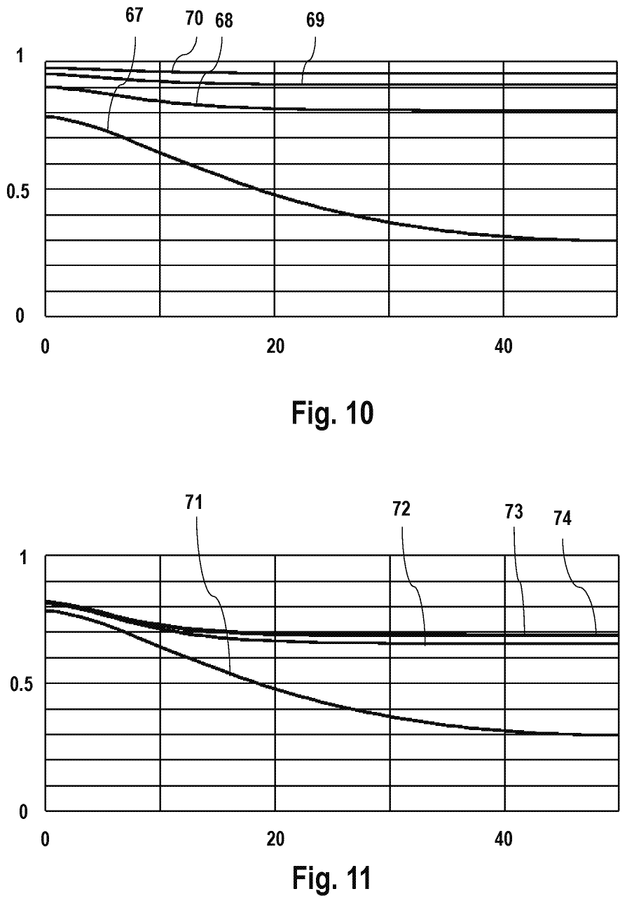

In an alternative illustration, FIG. 10 shows the reflectivity of an EUV mirror versus the thickness of the carbon layer. A first curve 67 shows the profile for carbon layers between 0 nm and 50 nm in the case of an angle of 16° at which the EUV radiation is incident on the optical surface of the EUV mirror. A second curve 68 shows the profile for an angle of 8°, a third curve 69 shows the profile for an angle of 4° and a fourth curve 70 shows the profile for an angle of 2°. The smaller the angle, the higher the reflectivity.

The invention opens up the possibility of increasing the service life of the optical system by enabling the apparatus to continue to operate even if the carbon layer 33 has grown beyond 10 nm. FIG. 5 shows a state of the deflection mirror 17 in which the carbon layer 33 has reached a thickness of 20 nm. In view of the small angle at which the EUV radiation is incident on the deflection mirror 17, the growth of the carbon layer 33 does not result in a greater loss of reflectivity. The reflectivity is still of the order of magnitude of 75% compared with the state illustrated in FIG. 3. With conventional grazing incidence at an angle of 20°, by contrast, the reflectivity would have already decreased to a value well below 20%.

The other EUV mirrors 18, 19, M1-M6 of the projection exposure apparatus are operated with normal incidence, such that the incident EUV radiation forms an angle of close to 90° with the respective optical surface. With normal incidence, the carbon layer that builds up during operation has significantly smaller effects on reflectivity compared to the situation with grazing incidence, such that the optical system can be operated expediently even if it is assumed that a carbon layer with a thickness of 20 nm has also deposited on the other EUV mirrors 18, 19, M1-M6.

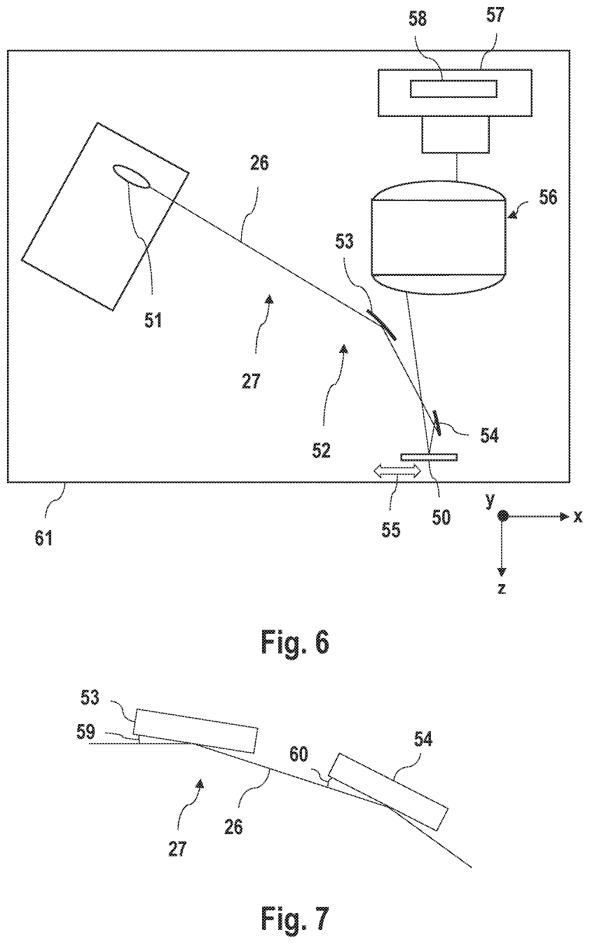

FIG. 6 shows a measuring device which can be used to examine microlithographic photomasks 50.

In the measuring device, the photomask 50 is arranged such that the EUV beam path 27 emanating from an EUV radiation source 51, only the central ray 26 of said beam path being illustrated in FIG. 6, is directed at the photomask 50 via an illumination system 52. The illumination system 52 comprises a first illumination mirror 53 and a second illumination mirror 54, at which the EUV beam path 27 is reflected and shaped into a beam which illuminates an examination field on the surface of the photomask 50 with uniform brightness. With an X-Y positioner 55, the photomask can be moved in the X-Y plane in order to bring different examination fields into the region of the EUV beam path 27.

The EUV beam path 27 reflected at the photomask 50 continues through a projection lens 56 to an EUV camera 57, which is equipped with an image sensor 58. The image sensor 58 can have an array of sensing elements or pixels. The projection lens 56 can comprise one or more EUV mirrors at which the EUV radiation is reflected and via which the examination field of the photomask 50 is imaged onto the image sensor 58 of the EUV camera 57. The EUV radiation source 51, the illumination system 52, the photomask 50, the projection lens 56 and the EUV camera 58 are arranged in a vacuum housing 61, in which a negative pressure prevails during the operation of the measuring device.

The EUV radiation source 51 is, e.g., a plasma radiation source, in which the EUV radiation is emitted from a plasma at a wavelength of, e.g., 13.5 nm. Tin is a medium that can be used to generate a plasma suitable for emitting such EUV radiation. A laser beam can be made to impinge on a droplet of the medium for the purpose of generating the plasma.

The components of the measuring device which deflect and shape the EUV beam path 27 between the EUV radiation source 51 and the EUV camera 57 form an optical system according to the invention. The first illumination mirror 53 and the second illumination mirror 54 are EUV mirrors of the optical system.

In accordance with FIG. 7, the EUV beam path 27 is incident on the first illumination mirror 53 at an angle 59 of, e.g., 8°. The EUV beam path 27 reflected at the first illumination mirror 53 is again incident on the second illumination mirror 54 at an angle 60 of, e.g., 8°. By virtue of each of the two illumination mirrors 53, 54 deflecting the EUV beam path 27 by, e.g., 16°, this results overall in a beam deflection of, e.g., 32° within one plane.

Compared with a state in which the illumination mirrors 53, 54 are new, i.e. no carbon layer 33 has formed yet, the reflectivity is reduced by less than 20% as a result of a 20 nm-thick carbon layer 33. As the thickness of the carbon layer 33 increases further, there is no further decrease in reflectivity (or the decrease in reflectivity is insignificant), such that even with a 50 nm-thick carbon layer 33, for example, the loss of reflectivity is still below 20%. The build-up of the carbon layer 33 thus no longer constitutes a practically relevant restriction of the time period over which the measuring device can be operated with the mirror arrangement from FIG. 7.

This is evident from FIG. 11, where the profile of reflectivity versus the thickness of the carbon layer is illustrated for a beam deflection of a total of 32°. The horizontal axis represents the thickness of the carbon layer for a single mirror. The vertical axis represents the reflectivity. A first curve 71 shows the profile of reflectivity between 0 nm and 50 nm thickness of the carbon layer for a single mirror. A second curve 72 shows the corresponding profile in the event that the beam deflection of 32° is effected by two mirrors. A third curve 73 for four mirrors and a fourth curve 74 for eight mirrors hardly differ from one another.

If a single EUV mirror were used instead for the beam deflection by 32°, the EUV beam path being incident on said mirror at an angle of 16°, then the reflectivity would decrease by more than 60% as a result of a 50 nm-thick carbon layer.

The loss of reflectivity can be further reduced to a certain extent if the beam deflection of 32° is effected by more than two EUV mirrors. This results in a loss of reflectivity of just over 16% with four EUV mirrors and an angle of 4° for the incident EUV radiation. This results in a loss of just less than 16% with eight EUV mirrors and an angle of 2° for the incident EUV radiation. In return for this slight improvement in reflectivity, higher equipment costs are accepted.

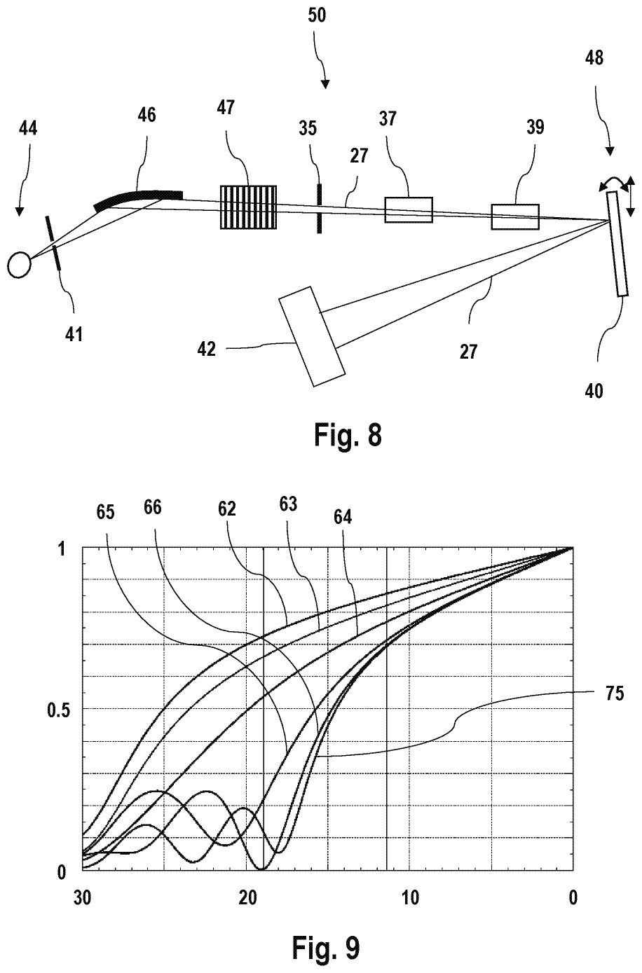

FIG. 8 illustrates a reflectometer comprising an optical system according to the invention.

In view of the large number of EUV mirrors 17, 18, 19, M1-M6 at which the EUV radiation is reflected in the microlithographic projection exposure apparatus from FIG. 1, it is important for the functionality of the microlithographic projection exposure apparatus that each individual one of the EUV mirrors has a high reflectivity for EUV radiation. Before assembly or in the context of maintenance or repair, it may therefore be desirable to measure the reflection properties of one or more EUV mirrors. This can be done using a reflectometer as illustrated in FIG. 8.

The reflectometer designed for the examination of a sample 40 comprises an EUV radiation source 44, from which the EUV radiation propagates through a stop 41. The optical system comprises a first collecting mirror 46, at which the EUV beam path 27 is shaped into a convergent beam. The EUV beam path 27 continues to the sample 40 via a monochromator 47, a stop 35, a second collecting mirror 37 and a beam splitter 39.

The monochromator 47 is designed as a grating monochromator configured such that only a narrowly delimited wavelength range around 13.5 nm, for example, can pass through the stop 35. The stop 35 has a slit-shaped opening, which is imaged onto the sample 40 by the second collecting mirror 37. In this case, the long dimension of the slit is oriented perpendicular to the image plane.

The beam splitter 39 deflects part of the EUV radiation out of the image plane in order to obtain a measure of the intensity of the EUV radiation incident on the sample 40.

After reflection at the sample 40, the EUV beam path 27 continues in a then divergent form again as far as a detector 42 designed as an EUV image sensor. The detector 42 registers the intensity of the incident EUV radiation pixel by pixel.

The sample 40 is held at a positioning system 48 indicated schematically in FIG. 2, by means of which the sample 40 can be displaced in a plane and tilted out of the plane. The positioning system 48 makes it possible to position the sample 40 such that the EUV radiation is incident on different surface areas of the sample 40, while the EUV beam path 27 reflected at the sample 40 propagates further in the direction of the detector 42 with unchanged positioning.

The optical elements which shape and deflect the EUV beam path 27 between the EUV radiation source 44 and the sample 40 form an optical system within the meaning of the invention. With the first collecting mirror 46 and the second collecting mirror 37, the optical system comprises a first EUV mirror and a second EUV mirror within the meaning of the invention. The central ray 26 of the EUV beam path 27 is incident at an angle of, e.g., 10° on both the first collecting mirror 46 and the second collecting mirror 37. In some implementations, the first collecting mirror 46 and the second collecting mirror 37 have mutually different incidence planes, such that the EUV beam path 27 is deflected out of the plane.

The optical system can be operated until the carbon layer formed during operation on the first collecting mirror 46 and the second collecting mirror 47 has reached a thickness of significantly more than 10 nm, for example 20 nm or 30 nm.

A number of embodiments of the invention have been described. Nevertheless, it will be understood that various modifications may be made without departing from the spirit and scope of the invention. Accordingly, other embodiments are within the scope of the following claims.

What is claimed is:

1. An optical system comprising an EUV mirror, wherein the EUV mirror is provided with an optical surface designed for the reflection of EUV radiation, wherein an EUV beam path generated by an EUV radiation source is directed at the optical surface of the EUV mirror, wherein the EUV beam path is incident on the EUV mirror at an angle of not more than 12°, wherein the optical surface is covered with a carbon layer.

2. The optical system of claim 1, wherein the carbon layer has a thickness of at least 8 nm.

3. The optical system of claim 1, wherein the carbon layer is a carbon layer deposited during the operation of the optical system.

4. The optical system of claim 1, wherein the optical surface is formed by a reflection layer having a thickness of between 20 nm and 200 nm.

5. The optical system of claim 1, wherein the optical surface is formed by a reflection layer of ruthenium.

6. The optical system of claim 1, wherein the angle between the EUV beam path and the optical surface is at least 4°.

7. The optical system of claim 1, comprising a first EUV mirror and a second EUV mirror, wherein the difference between the angle at which the EUV beam path is incident on the first EUV mirror and the angle at which the EUV beam path is incident on the second EUV mirror is smaller than 6°.

8. The optical system of claim 7, wherein the first EUV mirror and the second EUV mirror have the same incidence plane.

9. The optical system of claim 7, wherein the first EUV mirror and the second EUV mirror jointly effect a beam deflection of the EUV beam path which is between 24° and 48°.

10. The optical system of claim 7, wherein no further optical element that modifies the direction of the EUV beam path is arranged between the first EUV mirror and the second EUV mirror.

11. The optical system of claim 1, comprising one or more EUV mirrors on which the EUV beam path is incident at an angle of between 60° and 90°.

12. The optical system of claim 1, comprising a vacuum housing, in the interior of which the EUV mirror is arranged.

13. The optical system of claim 12, wherein a vacuum atmosphere without hydrogen purge gas is present in the vacuum housing.

14. A method for operating an optical system in which an EUV beam path generated by an EUV radiation source is directed at an optical surface of an EUV mirror, wherein the EUV beam path is directed at the EUV mirror at an angle of not more than 12°, wherein the optical surface is covered with a carbon layer.

15. The method of claim 14, wherein the carbon layer has a thickness of at least 8 nm.

16. The optical system of claim 1, wherein the optical surface is formed by a reflection layer having a thickness in a range from 30 nm to 80 nm.

17. The optical system of claim 1, wherein the angle between the EUV beam path and the optical surface is at least 6°.

18. The optical system of claim 1, wherein the angle between the EUV beam path and the optical surface is at least 8°.

19. The optical system of claim 7, wherein the difference between the angle at which the EUV beam path is incident on the first EUV mirror and the angle at which the EUV beam path is incident on the second EUV mirror is smaller than 4°.

20. The optical system of claim 1, wherein the difference between the angle at which the EUV beam path is incident on the first EUV mirror and the angle at which the EUV beam path is incident on the second EUV mirror is smaller than 2°.
